(19) United States
(12) Patent Application Publication
(10) Pub. No.: US 2025/0178421 A1
(43) Pub. Date: Jun. 5, 2025

(54) VEHICLE ENCLOSURE

(71) Applicant: Jeff Wiley, Frisco, TX (US)

(72) Inventor: Jeff Wiley, Frisco, TX (US)

(21) Appl. No.: 18/526,834

(22) Filed: Dec. 1, 2023

(51) Int. Cl. B60J 11/04

(52) U.S. Cl. CPC B60J 11/04

(57) ABSTRACT

An enclosure apparatus for preventing dust, water, pests, and the like from interfering with a vehicle includes a cover with a base panel and several other panels pivotally coupled to the base panel. The cover is positionable in a planar configuration wherein the base panel and other panels lie on a shared plane and in a use configuration wherein the cover encloses an interior volume. Fasteners such as zippers are used to couple the other panels together to retain the cover in the use configuration. A protective layer is coupled to the base panel to protect the base panel from damage caused by the vehicle moving across the base panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle enclosures and more particularly pertains to a new vehicle enclosure for preventing dust, water, pests, and the like from interfering with a vehicle.

### (2) Description of Related Art Including Information Disclosed Under 37 CFR 1.97 and 1.98

May types of vehicle enclosures collapse or fold into a compact or flattened state and are deployable from such a compact or flattened state to define an interior volume within which a vehicle may be stored and protected from various external hazards. Some vehicle enclosures include rigid panels which fold out to form a rigid housing. Some vehicle enclosures have canopies held up by a frame which folds out to hold the canopy over the vehicle. However, the prior art does not describe such an apparatus comprising flexible fabric panels which lie in a planar configuration when not in use to enclose a vehicle and which are positionable to releasably couple to each other and define an interior volume. Such an apparatus would provide an alternative means of protecting a vehicle than those of the prior art.

### BRIEF SUMMARY OF THE INVENTION

An embodiment of the disclosure meets the needs presented above by generally comprising a cover with a base panel, a first end panel, a second end panel, a first side panel, and a second side panel. The base panel has a first end and a second end and has a first lateral edge and a second lateral edge which each extend between the first end and the second end. The base panel has a size configured for supporting a vehicle thereon. The first end panel is pivotally coupled to the first end of the base panel, and the second end panel is pivotally coupled to the second end of the base panel. The first side panel is pivotally coupled to the first lateral edge of the base panel, and the second side panel is pivotally coupled to the second lateral edge of the base panel.

The cover is positionable in a planar configuration wherein the base panel lies on a shared plane with the first end panel, the second end panel, the first side panel, and the second side panel. The cover is also positionable in a use configuration wherein the cover defines an interior volume. The cover forms a tubular shape with the base panel and the first and second side panels which surrounds the interior volume when positioned in the use configuration. The first and second end panels are positioned to close open ends of the tubular shape when the cover is positioned in the use configuration.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of an enclosure apparatus according to an embodiment of the disclosure being moved from a planar configuration to a use configuration.

FIG. 2 is a perspective in-use view of an enclosure apparatus according to an embodiment of the disclosure being moved from a planar configuration to a use configuration.

FIG. 3 is a perspective in-use view of an enclosure apparatus according to an embodiment of the disclosure being moved from a planar configuration to a use configuration.

FIG. 4 is a perspective in-use view of an enclosure apparatus according to an embodiment of the disclosure being moved from a planar configuration to a use configuration.

FIG. 5 is a perspective in-use view of an enclosure apparatus according to an embodiment of the disclosure being moved from a planar configuration to a use configuration.

FIG. 6 is a side view of an embodiment of the disclosure in a use configuration.

FIG. 7 is a top view of an embodiment of the disclosure in a planar configuration.

FIG. 8 is a side in-use view of an embodiment of the disclosure in a use configuration.

### DETAILED DESCRIPTION OF THE INVENTION

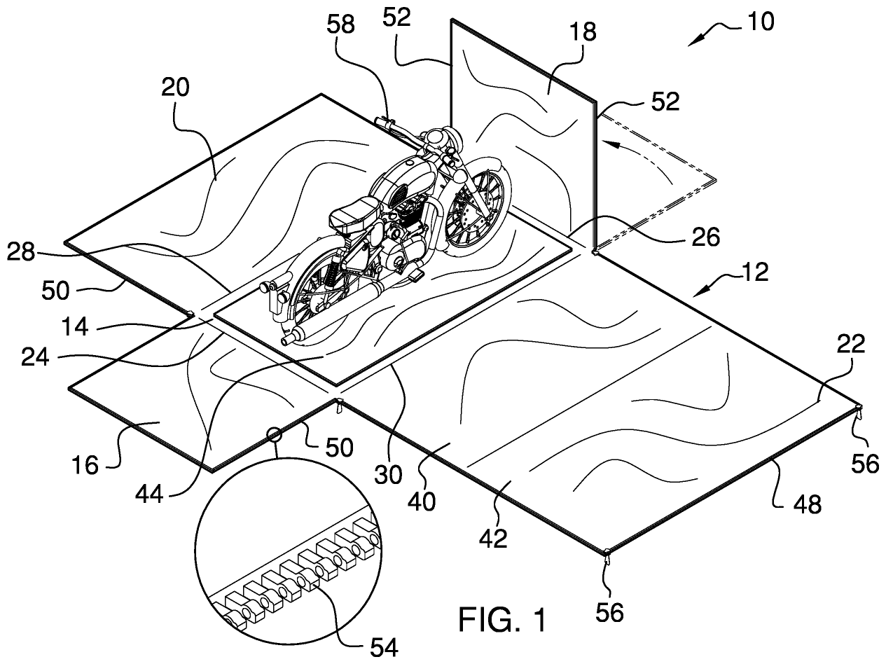

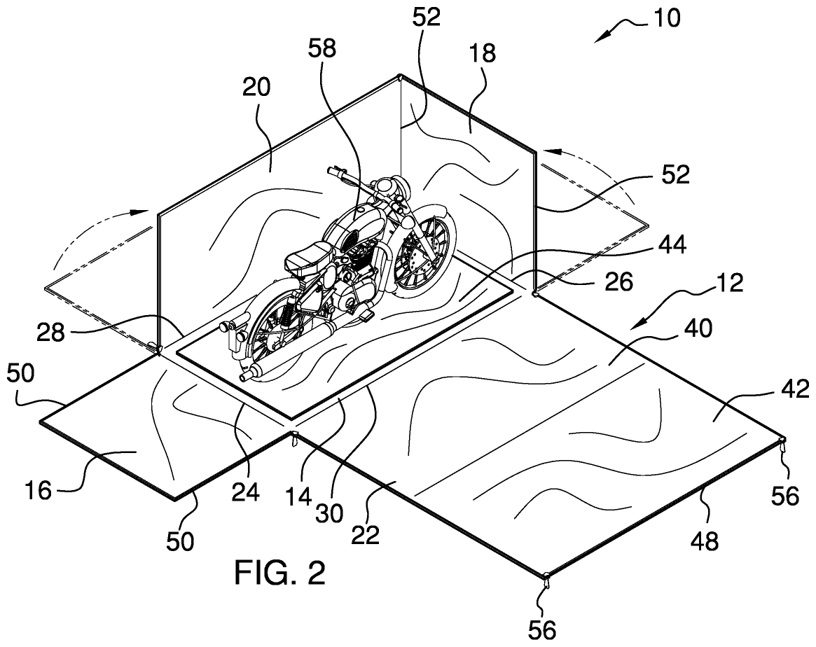

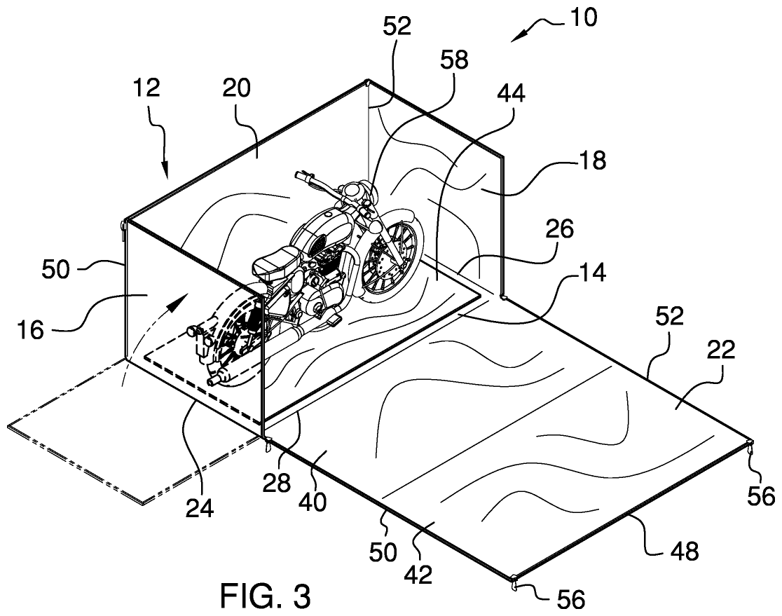

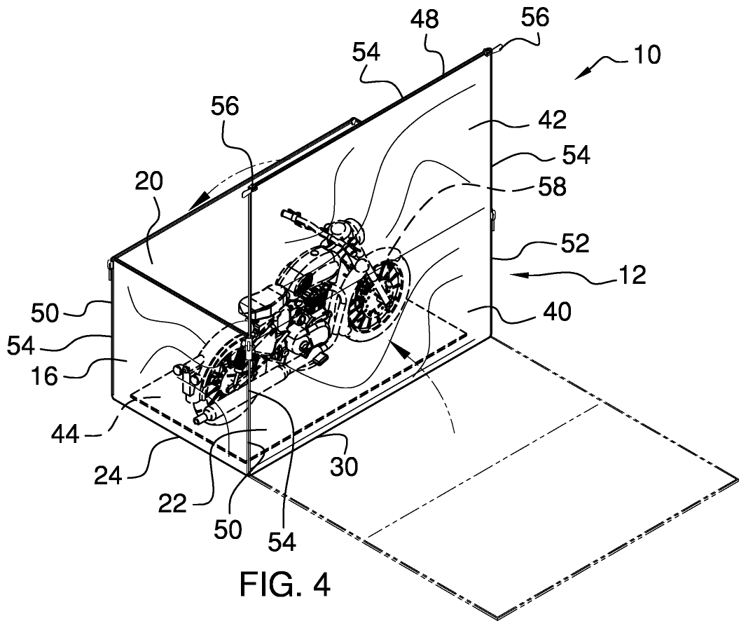

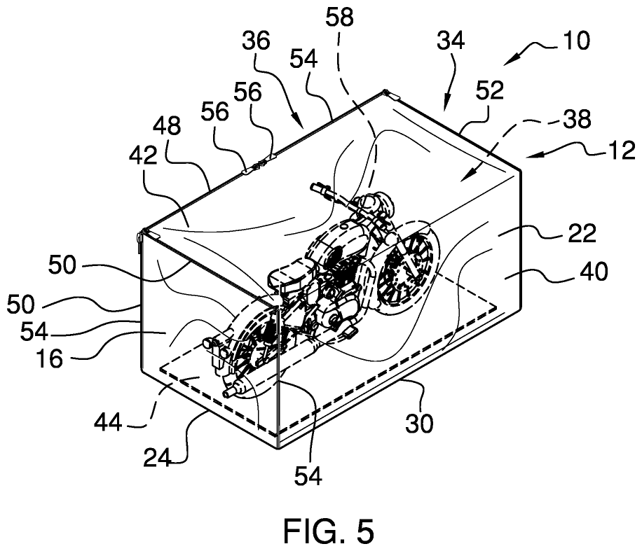

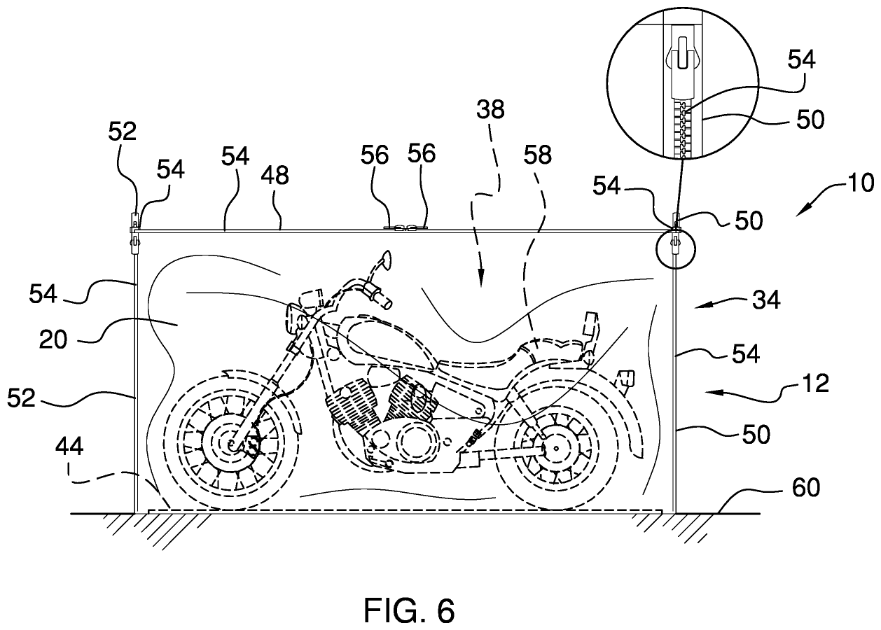

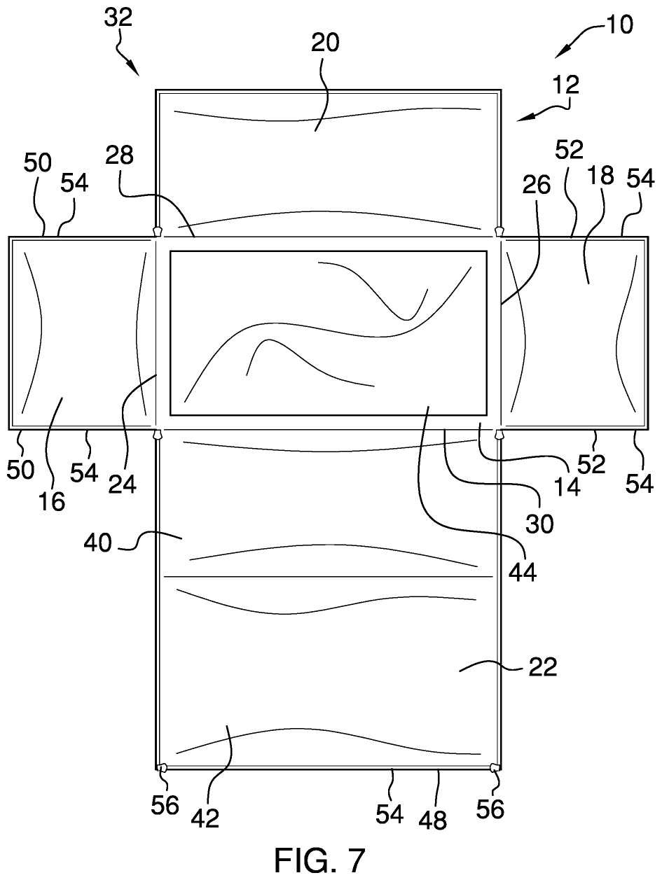

With reference now to the drawings, and in particular to FIGS. 1 through 8 thereof, a new vehicle enclosure embodying the principles and concepts of an embodiment of the disclosure and generally designated by the reference numeral 10 will be described.

As best illustrated in FIGS. 1 through 8, the enclosure apparatus 10 generally comprises a cover 12 with a base panel 14, a first end panel 16, a second end panel 18, a first side panel 20, and a second side panel 22. The base panel 14 has a first end 24 and a second end 26 and has a first lateral edge 28 and a second lateral edge 30 which each extend between the first end 24 and the second end 26. The base panel 14 also has a size configured for supporting a vehicle 58 thereon. The cover 12 is sized for motorcycles, all-terrain vehicle (ATV), utility task vehicle (UTV), or the like, but may be sized for larger vehicles such as sedans, sport utility vehicles (SUVs), pickup trucks, or the like. The first end panel 16 is pivotally coupled to the first end 24 of the base panel 14, and the second end panel 18 is pivotally coupled to the second end 26 of the base panel 14. The first side panel 20 is pivotally coupled to the first lateral edge 28 of the base panel 14, and the second side panel 22 is pivotally coupled to the second lateral edge 30 of the base panel 14.

The cover 12 is positionable in a planar configuration 32 wherein the base panel 14 lies on a shared plane with the first end panel 16, the second end panel 18, the first side panel 20, and the second side panel 22. The cover 12 is also positionable in a use configuration 34 wherein the cover 12 defines an interior volume 38. When positioned in the use configuration 34, the cover 12 forming a tubular shape 36 with the base panel 14 and the first and second side panels 20, 22 which surrounds the interior volume 38. The first and second end panels 16, 18 are positioned to close open ends of the tubular shape 36 when the cover 12 is positioned in the use configuration 34.

To retain the cover 12 in the use configuration 34, the first and second side panels 20, 22 are removably couplable to each other and the first and second end panels 16, 18 are removably couplable to each of the first and second side panels 20, 22 when the cover 12 is positioned in the use configuration 34. The first side panel 20 extends upwardly from the base panel 14 when the cover 12 is positioned in the use configuration 34. The second side panel 22 has a proximal portion 40 and a distal portion 42 with respect to the base panel 14. The proximal portion 40 is coupled to and extends upwardly from the base panel 14 when the cover 12 is positioned in the use configuration 34. The distal portion 42 is coupled to the proximal portion 40 and is spaced above the base panel 14 when the cover 12 is in the use configuration 34.

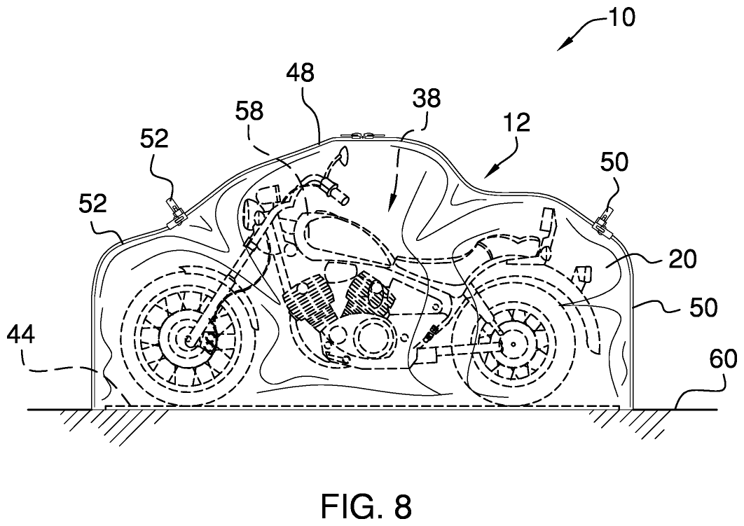

Each of the base panel 14, the first and second end panels 16, 18, and the first and second side panels 20, 22 comprise a flexible fabric material. The cover 12 has a unitary structure wherein the base panel 14, the first and second end panels 16, 18, and the first and second side panels 20, 22 pivot by the nature of the flexible fabric material. In order to present a clear view of how the panels move between the planar configuration 32 and the use configuration 34, FIGS. 1 through 6 show the base panel 14, the first and second end panels 16, 18, and the first and second side panels 20, 22 maintaining a planar orientation. However, as shown in FIG. 8, the cover 12 will collapse and drape over the vehicle 58 when at rest in the use configuration 34. The cover 12 may, however, include rigid panels in other embodiments. Each of the base panel 14, the first and second end panels 16, 18, and the first and second side panels 20, 22 have rectangular shapes but may have other suitable shapes in other embodiments.

A protective layer 44 is coupled to and lies atop the base panel 14. The protective layer 44 comprises a durable material configured to resist damage in response to the vehicle 58 moving across the protective layer 44. The durable material may comprise, for example, a durable fabric such as vinyl, canvas, or the like.

A plurality of fasteners is coupled to the cover 12 to selectively retain the cover 12 in the use configuration 34, the plurality of fasteners includes a side fastener 48, a pair of first end fasteners 50, and a pair of second end fasteners 52. The side fastener 48 is configured to couple the first and second side panels 20, 22 together. Each first end fastener 50 is configured to couple the first end panel 16 to a respective one of the first and second side panels 20, 22. Each second end fastener 52 is configured to couple the second end panel 18 to a respective one of the first and second side panels 20, 22. Each fastener of the plurality of fasteners comprises a zipper 54. The zipper 54 of the side fastener 48 comprises a pair of sliders 56 which slide toward each other to close the side fastener 48, but one slider may be used in other embodiments.

In use, the cover 12 is positioned in the planar configuration 32 on a ground surface 60. The vehicle 58 is placed on the protective layer 44 over the base panel 14. Then the cover 12 is moved into the use configuration 34, forming the cover 12 around the vehicle 58 to house the vehicle 58 in the interior volume 38 defined by the cover 12. The first side panel 20 is coupled to the second side panel 22, and each of the first and second end panels 16, 18 is coupled to each of the first and second side panels 20, 22. The flexible fabric material may be water impermeable to protect the vehicle 58 from water damage and may be resistant to damage from rodents and the like to prevent damage from the same. Dirt, leaves, and other debris will also be inhibited from soiling or damaging the vehicle 58.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An enclosure apparatus for a vehicle, the enclosure apparatus comprising:
a cover comprising:
a base panel having a first end and a second end, said base panel having a first lateral edge and a second lateral edge which each extend between the first end and the second end, the base panel having a size configured for supporting the vehicle thereon;
a first end panel pivotally coupled to the first end of the base panel;
a second end panel pivotally coupled to the second end of the base panel;
a first side panel pivotally coupled to the first lateral edge of the base panel; and
a second side panel pivotally coupled to the second lateral edge of the base panel;
wherein the cover is positionable in a planar configuration wherein the base panel lies on a shared plane with the first end panel, the second end panel, the first side panel, and the second side panel, the cover being positionable in a use configuration wherein the cover defines an interior volume, the cover forming a tubular shape with the base panel and the first and second side panels when positioned in the use configuration, the first and second end panels being positioned to close open ends of the tubular shape when the cover is positioned in the use configuration.

2. The apparatus of claim 1, wherein the first and second side panels are removably couplable to each other when the cover is positioned in the use configuration, the first and second end panels being removably couplable to each of the first and second side panels when the cover is positioned in the use configuration.

3. The apparatus of claim 2, further comprising a plurality of fasteners coupled to the cover to selectively retain the cover in the use configuration, the plurality of fasteners including:
a side fastener being configured to couple the first and second side panels together;
a pair of first end fasteners, each first end fastener being configured to couple the first end panel to a respective one of the first and second side panels; and
a pair of second end fasteners, each second end fastener being configured to couple the second end panel to a respective one of the first and second side panels.

4. The apparatus of claim 3, wherein each fastener of the plurality of fasteners comprises a zipper.

5. The apparatus of claim 1, wherein the first side panel extends upwardly from the base panel when the cover is positioned in the use configuration, the second side panel having a proximal portion and a distal portion with respect to the base panel, the proximal portion being coupled to and extending upwardly from the base panel when the cover is positioned in the use configuration, the distal portion being coupled to the proximal portion and being spaced above the base panel when the cover is in the use configuration.

6. The apparatus of claim 1, wherein each of the base panel, the first and second end panels, and the first and second side panels comprise a flexible fabric material.

7. The apparatus of claim 1, wherein the cover has a unitary structure.

8. The apparatus of claim 1, wherein each of the base panel, the first and second end panels, and the first and second side panels having rectangular shapes.

9. The apparatus of claim 1, further comprising a protective layer coupled to and lying atop the base panel, the protective layer comprising a durable material configured to resist damage in response to the vehicle moving across the protective layer.

10. An enclosure apparatus for a vehicle, the enclosure apparatus comprising:
a cover comprising:
a base panel having a first end and a second end, said base panel having a first lateral edge and a second lateral edge which each extend between the first end and the second end, the base panel having a size configured for supporting the vehicle thereon;
a first end panel pivotally coupled to the first end of the base panel;
a second end panel pivotally coupled to the second end of the base panel;
a first side panel pivotally coupled to the first lateral edge of the base panel; and
a second side panel pivotally coupled to the second lateral edge of the base panel;
wherein the cover is positionable in a planar configuration wherein the base panel lies on a shared plane with the first end panel, the second end panel, the first side panel, and the second side panel, the cover being positionable in a use configuration wherein the cover defines an interior volume, the cover forming a tubular shape with the base panel and the first and second side panels when positioned in the use configuration, the first and second end panels being positioned to close open ends of the tubular shape when the cover is positioned in the use configuration, the first and second side panels being removably couplable to each other when the cover is positioned in the use configuration, the first and second end panels being removably couplable to each of the first and second side panels when the cover is positioned in the use configuration, the first side panel extending upwardly from the base panel when the cover is positioned in the use configuration, the second side panel having a proximal portion and a distal portion with respect to the base panel, the proximal portion being coupled to and extending upwardly from the base panel when the cover is positioned in the use configuration, the distal portion being coupled to the proximal portion and being spaced above the base panel when the cover is in the use configuration;
wherein each of the base panel, the first and second end panels, and the first and second side panels comprise a flexible fabric material, the cover having a unitary structure, each of the base panel, the first and second end panels, and the first and second side panels having rectangular shapes;
a protective layer coupled to and lying atop the base panel, the protective layer comprising a durable material configured to resist damage in response to the vehicle moving across the protective layer; and
a plurality of fasteners coupled to the cover to selectively retain the cover in the use configuration, the plurality of fasteners including:
a side fastener being configured to couple the first and second side panels together;
a pair of first end fasteners, each first end fastener being configured to couple the first end panel to a respective one of the first and second side panels; and
a pair of second end fasteners, each second end fastener being configured to couple the second end panel to a respective one of the first and second side panels;
wherein each fastener of the plurality of fasteners comprises a zipper.
